(19) United States
(12) Patent Application Publication
(10) Pub. No.: US 2020/0393278 A1
(43) Pub. Date: Dec. 17, 2020

(54) Device for Compensating Viscosity-Induced Measurement Errors, for Coriolis Flow Measurement

(71) Applicant: Heinrichs Messtechnik GmbH, Köln (DE)

(72) Inventor: Thomas Chatzikonstantinou, Aachen (DE)

(21) Appl. No.: 16/440,363

(22) Filed: Jun. 13, 2019

(51) Int. Cl. G01F 1/84

(52) U.S. Cl. CPC G01F 1/8436; G01F 1/8422; G01F 1/8468

(57) ABSTRACT

Embodiments of a device for compensating viscosity-induced measurement errors, for Coriolis flow measurement, employ a measuring transformer and a meter electronic unit.

### TECHNICAL FIELD

The invention relates to a device for compensating viscosity-induced measurement errors, for Coriolis flow measurement, according to the preamble of claim 1.

### BACKGROUND AND SUMMARY

Devices for Coriolis flow measurement are known from the prior art (see for example DE 20 2017 006 709 U1) and are used in particular to determine the mass throughput and/or the density of a flowing fluid. Coriolis flow meters have at least one measuring tube in a measuring transformer, which measuring tube is flowed through by the fluid whose mass throughput and/or density is to be determined. The at least one measuring tube is set in vibration by way of a vibration generator, while the vibrations of the measuring tube are measured by way of vibration sensors at the same time at separate measurement points. If no fluid flows through the measuring tube during the measurement, the measuring tube vibrates with the same phase at both measurement points. By contrast, when fluid flows, phase shifts occur at the two measurement points due to Coriolis forces that arise, which phase shifts are a direct measure for the mass throughput, that is to say for the mass of the fluid flowing per unit of time, through the measuring tube in question. In addition, the natural frequency of the measuring tube at the measurement points is directly dependent on the density of the flowing fluid, such that the density thereof is likewise able to be determined.

Coriolis flow meters are used in many technological fields, such as for example in pipeline calculation measurements, in loading procedures, for example in the loading of tankers with crude oil or gas, or in metering procedures. Coriolis flow meters are calibrated using a fluid calibration medium, which is often water.

The influence of the determinants mass flow and/or density on the measured variables phase shift or frequency depends not only on the structure of the respective Coriolis flow meter, but rather also on temperature, pressure and viscosity of the medium to be measured. The use of temperature compensation is thus known for correcting temperature-induced measurement errors of Coriolis flow meters. To this end, the temperature of the fluid is continuously measured by way of a temperature sensor installed at a suitable location on the Coriolis flow meter and density and/or mass flow is set in relation to a reference state, here a reference temperature, using mostly linear approximation formulae. A similar approach is adopted, that is to say using mostly linear approximation formulae in relation to a reference state, here a reference pressure, to correct pressure-induced measurement errors of Coriolis flow meters. Coriolis mass flow meters normally do not have a pressure sensor, for which reason, unlike the temperature, the pressure is not measured continuously, but rather is input by the user, usually manually, on the electronic evaluation unit. Density and flow correction formulae, for example using linear temperature and pressure compensation, are known in the prior art.

Unlike in the case of temperature and pressure, the influence of viscosity on the measurement results of Coriolis mass flow meters is largely ignored in the prior art. Even in standard works in flow metrology, such as for example in the book “Flow Measurement”, Bela G. Liptak, CRC Press, ISBN 9780801983863, page 60, it is stated that only a small amount of documented information is available about the influence of viscosity on the accuracy of Coriolis flow meters, but also that such inaccuracies have been reported but without confirming these through documented test data.

Due to the constantly increasing requirements with regard to the accuracy of Coriolis flow meters, the viscosity of the fluid to be measured is increasingly cited as a possible error source, on the one hand (see for example “Factors Affecting Coriolis Flowmeters”, Chris Mills, NEL, 25.03.2014). On the other hand, however, the influence of viscosity on the measurement results of Coriolis mass flow meters is afforded hardly any importance in practice. Thus, for example, looking through the operating manuals from leading manufacturers of Coriolis mass flow meters has revealed that, to date, these do not read the viscosity values of the fluid to be measured into the electronic evaluation unit of the Coriolis mass flow meter or process them. In spite of this, significant measurement errors occur, in particular at low Reynolds numbers, which may constitute several percentage points, in particular if—as is often the case—water is used as calibration medium. This effect is particularly pronounced when using a device calibrated with water in the case of use for a fluid having high to very high viscosity. The same applies for very large Coriolis flow meters, such as are used for example at large loading terminals for hydrocarbons or bitumen. In the case of small viscosities and at the same time very small mass flows of the fluid as well, however, such as is the case for example for small Coriolis flow meters that are used in the field of kilograms per hour, measurement errors based on the influence of viscosity should not be ignored.

WO 2015/086224 A1 discloses a density meter, in particular Coriolis mass flow/density meter, in which it is proposed, in order to measure the density or the mass flow of the fluid flowing through a measuring transformer, not to use the resonant frequency of the measuring transformer measuring tube, but rather to use a frequency deviating therefrom, which is intended to result in a preferred phase shift. The optimum measurement frequency is supposed to lead to independence from the influence of the viscosity on the measurement result. The optimum phase shift angle may be determined experimentally and/or using simulation calculations.

In the assessment of the previous prior art, it is revealed in WO 2015/086224 A1 that the damping of the useful vibrations, brought about through dissipation of vibration energy in heat, is also a further influencing variable that may influence the resonant frequency, serving as used frequency, to a not readily negligible extent or may have a certain cross-sensitivity with respect to the density meter. Changes in the damping and associated changes in the corresponding resonant frequency are supposed to also be determined to a considerable extent by changes in the viscosity of the respective medium to be measured in the case of an intact measuring transformer, and this is performed such that the respective resonant frequency decreases as viscosity increases, despite density remaining constant. It was proposed here to correct the change in the resonant frequency by initially determining the viscosity of the fluid flowing through the measuring transformer from the measurement signals of the measurement transformer by way of the meter electronics. The measured variable to be determined—here the density value of the fluid—is able to be determined using the viscosity measured value and a correspondingly expanded characteristic curve function, namely one that also takes into consideration the change in the resonant frequency brought about by changes in the viscosity.

DE 100 20 606 A1 discloses devices and methods for Coriolis flow measurement that allow the viscosity to be determined and at the same time the density and mass flow of the flowing fluid to be measured.

U.S. Pat. No. 5,027,662 A discloses a Coriolis flow meter in which a viscosity-dependent damping is taken into consideration in particular embodiments for determining the mass flow. To this end, the damping is determined from the measured values without the viscosity values themselves being determined.

It is known from “Numerical Simulations of Coriolis Flow Meters for Low Reynolds Number Flows” (Vivek Kumar and Martin Anklin, Endress+Hauser FLOWTEC Journal of Metrology Society India, Vol 26, No 3, 2011, pp. 225-235) that there is a need to correct the measured values of Coriolis flow meters in the case of low Reynolds numbers, and this is performed on individual terms at said manufacturer using the Reynolds number. The Reynolds number is indirectly proportionally dependent on the dynamic viscosity and proportionally dependent on the fluid velocity of the fluid and the nominal diameter of the measuring tube. The Reynolds number is therefore however only a similarity parameter and, as such, is very useful in many flow technology applications, but, due to the further dependencies, is not sufficient for taking into consideration the influence, especially of viscosity, in Coriolis flow meters. This viscosity compensation on the basis of the Reynolds number is independent of the structure of the Coriolis flow meter, that is to say for example of the form of the measuring tube, which normally runs in a loop shape, of the housing and of the material, since a correction function according to the Reynolds number treats Coriolis flow meters of different sizes and fitted with different loop shapes in the same way if they proceed to Reynolds areas relevant to correction during operation. These may be relatively large but also very small Coriolis flow meters, depending on velocity and viscosity.

Using the compensation based on the Reynolds number, important local effects, which are connected to the features of the type of device and influence the measurement accuracy, remain unconsidered. In addition, the Reynolds number is not able to be used for moving objects, such as the vibrating measuring tubes of a Coriolis flow meter. Further disadvantages of using the Reynolds number result for example in the case of locally different diameters or even through local folds, arising as a result of measuring tube bending processes, in the wall of the measuring tubes, and in the case of different surface qualities of the inside of the measuring tubes.

EP 1 281 938 B1 discloses taking into consideration the viscosity of the fluid in order to correct an intermediate value determined for the mass flow of a fluid. To this end, the viscosity is measured and a further measurement signal, representative of the Reynolds number, is produced from the measurement signal representative of the viscosity and the intermediate value, using which further measurement signal the intermediate value is then corrected. The Reynolds number is thus ultimately decisive, which entails the problems, already outlined further above, with regard to the accuracy of the measured value.

EP 1725839 B1 discloses a Coriolis mass flow meter, during operation of which the viscosity of the fluid flowing through the meter is taken into consideration in order to compensate measurement errors in the mass flow measurement. The viscosity measured value is determined during operation or is determined beforehand as a predefined reference viscosity and, with knowledge of the medium to be measured, is input manually from a remote control room or in situ.

The invention is based on the technical problem of providing a device of the type mentioned at the outset, which allows improved consideration of the influence of the viscosity on the measurement result.

With regard to the device of the type mentioned at the outset, this problem is solved by the characterizing features of claim 1. Advantageous refinements of the device according to the invention emerge from the dependent claims.

Accordingly, the device for Coriolis flow measurement, which has a measuring transformer and a meter electronic unit, is characterized in that the meter electronic unit has an input interface for inputting at least one viscosity value of the fluid. The viscosity value may be input as a numerical value having a physical unit, for example mPas, or in another form unambiguously identifying the viscosity value, for example using a key number or a name for the fluid. The association may take place via a data table stored for example in the meter electronic unit.

The viscosity of the fluid therefore does not have to be measured, but rather may be input via the input interface if the fluid is known. Inputting an individual value that is correct for example for predefined standard conditions, such as room temperature and normal pressure, may be sufficient. Actual environmental conditions, such as the operating temperature and the operating pressure, may be established automatically or predefined, such that the viscosity values for the operating conditions are able to be determined using table values and/or characteristic diagrams and/or mathematical methods. The operating conditions to be taken into consideration may also include flow velocity, in particular for thixotropic fluids, whose viscosity may depend on the flow velocity. This gives a very practical and user-friendly solution for providing viscosity data that may be used to compensate viscosity-related measurement errors.

If the dependency of the measured variable to be determined, for example of the mass flow, on the viscosity is known and is able to be represented mathematically or if it is stored in table form or in a characteristic diagram, for example by way of a calibration method, the viscosity input interface may be used to supply the meter electronic unit with an appropriate viscosity value, so that said value is able to be taken into consideration by the evaluation electronics for the end result of the measured variable.

It is thus possible to dispense with measurement-based determination of the viscosity on the measuring transformer or on another apparatus.

The device according to the invention may also be designed such that the input interface is configured so as to input the at least one viscosity value as a mathematical function. This may take place for example in the form of a polynomial or spline. The mathematical function may for example represent or approximate the viscosity value depending on temperature, pressure and/or flow velocity. There may be provision for example to input discrete viscosity values and an approximation function.

The device according to the invention may thus also be designed such that the input interface is a manual input interface. A person operating the device is thus able to input the viscosity value, known to him or taken from a source, of the fluid in the meter electronic unit.

The term viscosity comprises both kinematic viscosity and dynamic viscosity, which are able to be converted to one another using the density of the fluid.

The device according to the invention may furthermore be designed such that the input interface is configured so as to obtain the at least one viscosity value from an apparatus outside the device in a wireless or wired manner. The input interface may also combine the manual input and the wireless or wired input by way of automatic data transmission. Thus, for example, the operator may stipulate the material of the fluid, whereas information about further variables that determine the viscosity, such as for example temperature and pressure, are taken automatically from a further unit.

The input interface may additionally be used to input further information, such as for example units of measurement, damping and minimum or maximum flow. Likewise, a display unit of the input interface may display further information in addition to the viscosity value, such as for example measurement results and/or parameters of measurements, for example mass flow, volume flow, density or temperature. The input interface may thus be designed so as to be multifunctional.

The Coriolis flow meter according to the invention may have more than one measuring tube. The claims are therefore not restricted to such devices having just one measuring tube.

One preferred embodiment of the device according to the invention is illustrated below with reference to figures.

### BRIEF DESCRIPTION OF THE DRAWINGS

FIG. 1: shows an input interface unit for measuring the Coriolis mass flow before inputting of a viscosity value, and

FIG. 2: shows the input interface unit according to FIG. 1 after inputting of a viscosity value.

### DETAILED DESCRIPTION

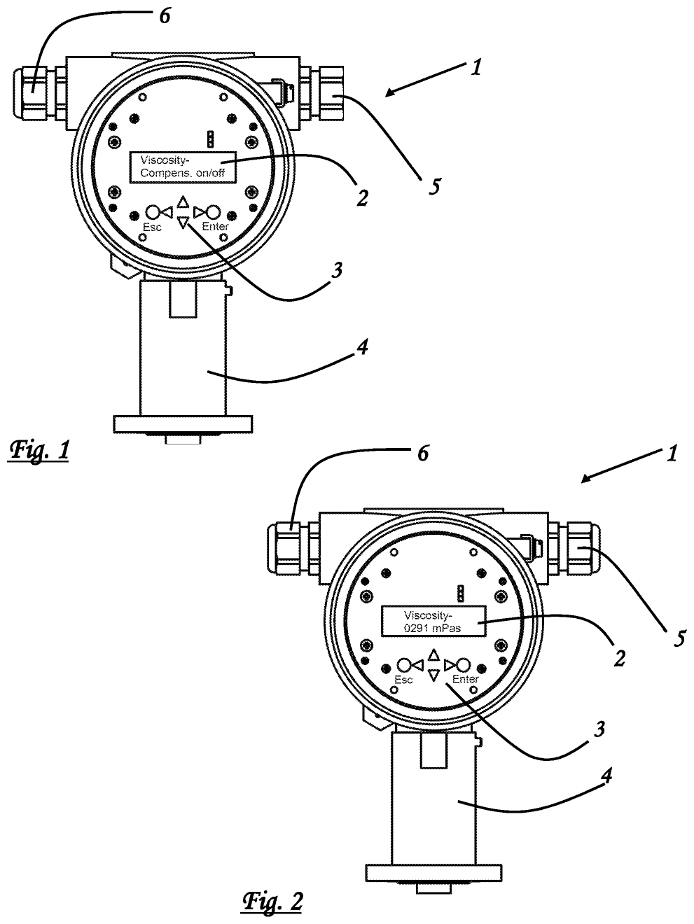

FIG. 1 shows an input interface unit 1 having a display unit 2, an input field 3, a foot 4, used for attachment to an apparatus that is not illustrated here, and a first connection element 5 and a second connection element 6 for the connection of electric supply lines, signal lines or other elements, which are not illustrated here. The input interface unit 1 is used for connection to a device, not illustrated here, for the Coriolis flow measurement of a fluid.

As illustrated by way of example in FIG. 1, it is able to be selected in the input field whether or not viscosity compensation should be used for the measurement. In the case of viscosity compensation, the influence of the viscosity of the fluid flowing through the measurement device is taken into consideration for the measurement result. To this end, a specific viscosity value, which is taken into consideration for the Coriolis flow measurement, is able to be input via the input field 3. The input interface unit 1 at the same time constitutes the meter electronic unit or forms part thereof. In the first case, the measurement signals may be evaluated in the input interface unit 1 itself. The viscosity value may also however be transmitted to a further part, not illustrated here, of the meter electronic unit for evaluation purposes in a wired or wireless manner.

As an alternative or in addition to the input field 3, the input interface unit 1 may also be supplied with the viscosity value by other means, such as for example by a further unit via a wired or wireless information transmission path.

### LIST OF REFERENCE SIGNS

1 Input interface unit

2 Display unit

3 Input field

4 Foot

5 Connection element

6 Connection element

1. A device for compensating viscosity-induced measurement errors, for Coriolis flow measurement, comprising:
a) a measuring transformer, wherein the measuring transformer has a measuring tube intended to be flowed through by a fluid, a vibration generator for generating measurement signals in the form of mechanical vibrations at the measuring tube and vibration sensors for sensing the vibrations of the measuring tube, and
b) a meter electronic unit, wherein the meter electronic unit is configured so as to determine a measured value for at least one desired measured variable from measurement signals transmitted from the measuring transformer to the meter electronic unit, wherein
c) the meter electronic unit has an input interface (1) for inputting at least one viscosity value of the fluid.

2. The device according to claim 1, wherein the input interface is configured so as to input the at least one viscosity value as a mathematical function.

3. The device according to claim 1, wherein the input interface is a manual input interface.

4. The device according to claim 1, wherein the input interface is configured so as to obtain the at least one viscosity value from an apparatus outside the device in a wireless or wired manner.

5. The device according claim 1, wherein the meter electronic unit is configured so as to process the at least one viscosity value or a correction value derived from the at least one viscosity value in order to correct the measured variable.

6. The device according claim 1, wherein the measured variable or one of the measured variables is a mass flow of the fluid.

7. The device according claim 1, wherein the meter electronic unit has a storage apparatus, wherein the storage apparatus is configured so as to store a table or a characteristic diagram, wherein the table or the characteristic diagram contains viscosity values of the fluid depending on at least one further variable, in particular on at least one of the variables temperature, pressure and flow velocity.
